(19) United States
(12) Patent Application Publication
(10) Pub. No.: US 2018/0208425 A1
(43) Pub. Date: Jul. 26, 2018

(54) SHEET SORTING DEVICE

(71) Applicants: KABUSHIKI KAISHA TOSHIBA, Tokyo (JP); TOSHIBA TEC KABUSHIKI KAISHA, Tokyo (JP)

(72) Inventor: Yuuichi AKIYAMA, Numazu Shizuoka (JP)

(21) Appl. No.: 15/683,293

(22) Filed: Aug. 22, 2017

(30) Foreign Application Priority Data
Jan. 25, 2017 (JP) 2017-011504

(51) Int. Cl. B65H 43/04; B65H 29/62; B07C 5/342; B41M 7/00

(52) U.S. Cl. CPC B65H 43/04; B65H 29/62; B07C 5/342; B65H 2301/51121; B65H 2408/111; B65H 2511/411; B41M 7/0009

(57) ABSTRACT

A sheet sorting device according to an embodiment includes a transporting unit that transports a sheet. A reading unit generates an image of a surface of the sheet. A decoloring unit performs a decoloring processing to decolor an image on the sheet. The sheet sorting device includes a plurality of sheet stacking trays. A processor causes the reading unit to generate an image of the surface of the sheet after the decoloring unit performs the decoloring processing on the sheet. The processor determines a color of the sheet based on the generated image. The processor determines one sheet stacking tray out of the plurality of sheet stacking trays as a transport destination of the sheet, based on the determined color. The transporting unit transports the sheet to the determined sheet stacking tray.

### CROSS-REFERENCE TO RELATED APPLICATION

This application is based upon and claims the benefit of priority from Japanese Patent Application No. 2017-011504, filed Jan. 25, 2017, the entire contents of which are incorporated herein by reference.

### FIELD

Embodiments described herein relate generally to a sheet sorting device and a related non-transitory computer readable medium.

### BACKGROUND

In the related art, a decoloring device performs a decoloring process on a medium, such as a sheet, on which an image is formed, thereby decoloring the image and causing the sheets to be reusable. A related technology includes obtaining images on sheets after the decoloring process, determining whether the sheets are reusable, and sorting and discharging the sheets to respective trays. However, even if colors (white, green, blue, or the like) of the image after the decoloring process are different from each other, the above-described technology discharges the media to the same reusable tray. Therefore, a user has to manually sort the media according to the differences in color of the residual image after discharging.

### DESCRIPTION OF THE DRAWINGS

FIG. 1 is a block diagram showing example components of a sorting device.

FIG. 2 is a diagram showing an example configuration of the sorting device.

FIG. 3 is a diagram showing transport of a medium through a first transport path of the sorting device.

FIG. 4 is a diagram showing transport of the medium through a second transport path of the sorting device.

FIG. 5 is a diagram showing transport of the medium through the first transport path of the sorting device after a decoloring process.

FIG. 6 is a flowchart showing an example sorting process of the sorting device.

FIG. 7 illustrates an example data format used for sorting.

### DETAILED DESCRIPTION

Embodiments provide a sorting device capable of easily sorting media having different residual colors after a decoloring process.

A sheet sorting device according to an embodiment includes a transporting unit that transports a sheet. A reading unit generates an image of a surface of the sheet. A decoloring unit performs a decoloring processing to decolor an image on the sheet. The sheet sorting device includes a plurality of sheet stacking trays. A processor causes the reading unit to generate an image of the surface of the sheet after the decoloring unit performs the decoloring processing on the sheet. The processor determines a color of the sheet based on the generated image. The processor determines one sheet stacking tray out of the plurality of sheet stacking trays as a transport destination of the sheet, based on the determined color. The transporting unit transports the sheet to the determined sheet stacking tray.

Hereinafter, a sheet sorting device and a related program according to an embodiment will be described with reference to the drawings. In the embodiment, “decoloring” means to visually obscure an image formed with a color different from a background color (including not only chromatic color but also achromatic color such as white and black) of an image formation target medium, such as, for example, a sheet.

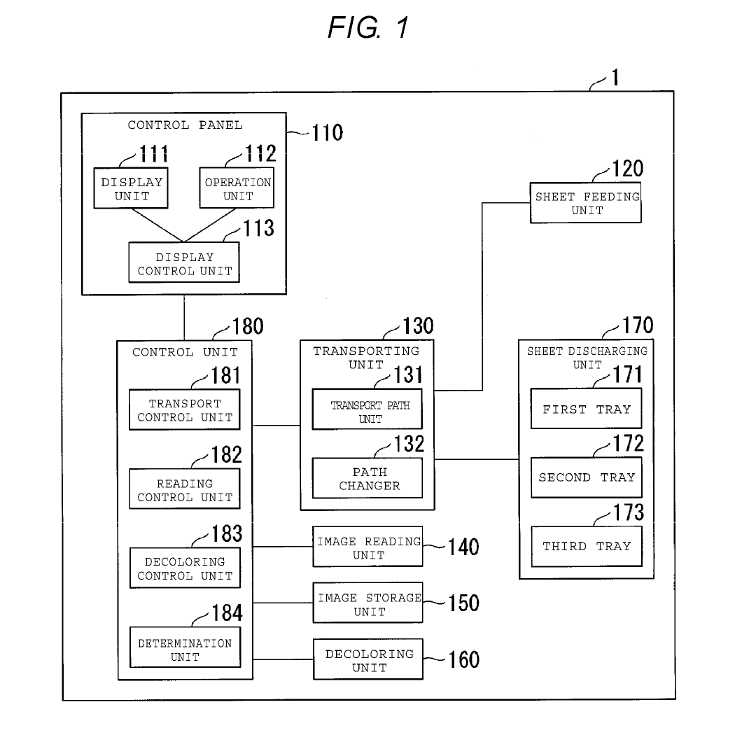

FIG. 1 is a block diagram showing example components of a sheet sorting device (e.g., sorting device 1) according to the embodiment. The sorting device 1 includes a control panel 110, a sheet feeding unit 120, a transporting unit 130, an image reading unit 140, an image storage unit 150, a decoloring unit 160, a sheet discharging unit 170, and a control unit 180.

The control panel 110 includes a display unit 111, an operation unit 112, and a display control unit 113. For example, the display unit 111, the operation unit 112, and the display control unit 113 are provided as a touch panel liquid crystal display. The display unit 111 displays information relating to the sorting device 1. The operation unit 112 generates device control information in response to an operation by a user. The display control unit 113 controls display on the display unit 111. The operation unit 112 may receive the operation by the user via a push button, a dial button, or the like instead of the touch panel.

The sheet feeding unit 120 includes a tray. Sheets to be reused are stacked on the tray of the sheet feeding unit 120. The sheet feeding unit 120 supplies the sheets to an inside of the sorting device 1 in order to decolor images formed on the sheets. The sheet feeding unit 120 picks up the sheets stacked on the tray one-by-one, and feeds the picked up sheet to the inside of the sorting device 1.

The transporting unit 130 includes a transport path unit 131 and path changers 132. The transporting unit 130 is configured with mechanical components such as a plurality of rollers and motors, and electronic components for electronically controlling the rollers and motors. The transport path 131 is a transport path for transporting the sheet. The path changers 132 each include a switching unit that are moved by a drive unit that receives an input from a user and a determination result from a determination unit 184 (described below), and that controls conveyance of the sheet to a predetermined transport path.

The image reading unit 140 includes an image sensor such as a charge-coupled device (CCD) sensor or a complementary metal oxide semiconductor (CMOS) sensor. The image reading unit 140 generates an image of a sheet by imaging a surface of the transported sheet. The image reading unit 140 is an example of a reading unit.

The image storage unit 150 is a storage device such as a magnetic hard disk device or a semiconductor storage device. The image storage unit 150 stores the image data generated by the image reading unit 140.

The decoloring unit 160 includes: a heat source such as a heat lamp, a heat roller, a press roller, and a temperature sensor. The heat source heats the heat roller. The heat roller comes into contact with a printed surface of the sheet and transports the sheet while heating the sheet. The press roller is positioned on the opposite side of the sheet across from the heat roller. The sheet is transported through a nip formed by the heat roller and press roller. The temperature sensor detects a temperature of the heat roller. The decoloring unit 160 decolors the image on the sheet by applying a temperature which is equal to or higher than a predetermined temperature or heating the sheet through the heat roller heated by the heat source. A decoloring process is the process of decoloring the image on the sheet.

The sheet discharging unit 170 includes trays which serve as sheet discharge destinations of the sheets to which various processes are applied. A plurality of trays may be provided. For example, the sheet discharging unit 170 includes a first tray 171, a second tray 172, and a third tray 173. The first tray 171, the second tray 172, and the third tray 173 are sheet stacking units. In this case, for example, the sheets after the decoloring process that the determination unit 184 determines to be non-reusable are discharged to the first tray 171. In addition, the sheets after the decoloring process that the determination unit 184 determines to be usable are sorted and discharged to the second tray 172 and the third tray 173 based on color difference of the sheets. The number of trays is not limited to three, and may be four or more.

The control unit 180 includes a transport control unit 181, a reading control unit 182, a decoloring control unit 183, and a determination unit 184. In one embodiment, the control unit 180 is a processor that is programmed to carry out the functions of the transport control unit 181, the reading control unit 182, the decoloring control unit 183, and the determination unit 184. In another embodiment, the control unit 180 is a hardware controller, e.g., an application specific integrated circuit (ASIC), a programmable logic device (PLD) or a field programmable gate array (FPGA), that is configured to carry out the functions of the transport control unit 181, the reading control unit 182, the decoloring control unit 183, and the determination unit 184.

The transport control unit 181 receives input from the user and a determination result of the determination unit 184 (described below). The transport control unit 181 controls conveyance of the sheet in the transporting unit 130 (controls transporting to predetermined transport destination, a transport speed, or the like) based on the determination result. The transport control unit 181 is an example of a sheet discharge destination control unit.

The reading control unit 182 controls the image reading unit to generate an image of a surface of the sheet before the decoloring process and after the decoloring process.

The decoloring control unit 183 controls the decoloring unit 160 to perform the decoloring process on the sheet.

The determination unit 184 determines reusability of the sheet to which the decoloring process is applied and color of the sheet based on the image generated by the image reading unit 140.

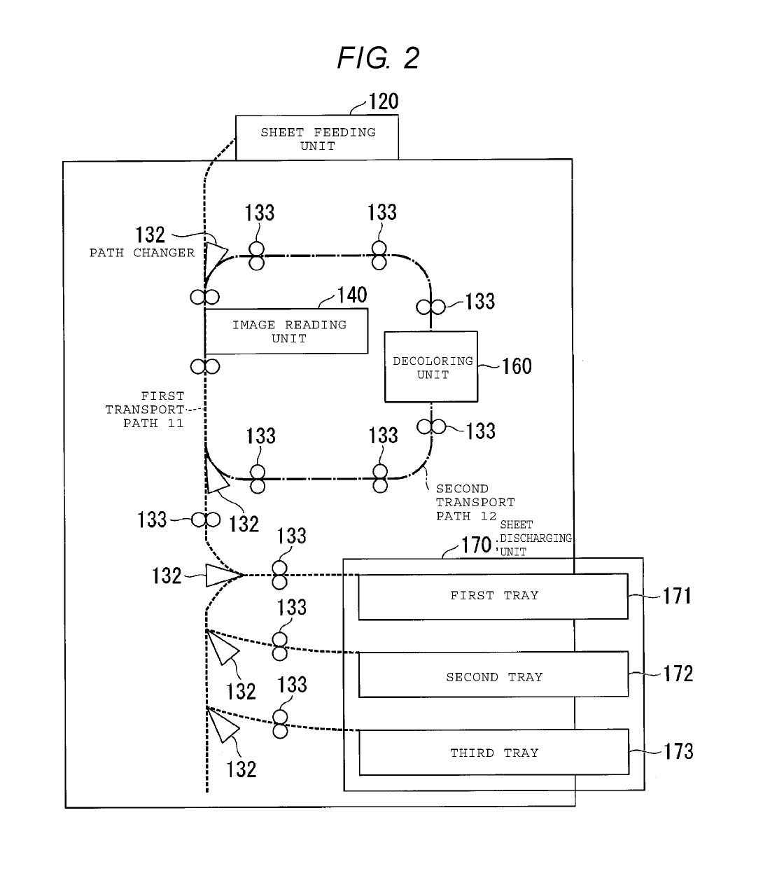

FIG. 2 is a diagram showing an example configuration of the sorting device 1. FIG. 2 shows an example where the number of trays of the sheet discharging unit 170 is three. The number of trays of the sheet discharging unit 170 is not limited to three as described above.

A first transport path 11 starts from the sheet feeding unit 120 and ends at each tray of the sheet discharging unit 170. A second transport path 12 branches off the first transport path 11 at a branch point of the first transport path 11 downstream of the image reading unit 140, and joins the first transport path 11 at a junction which is upstream of the image reading unit 140 on the first transport path 11. The path changers 132 are disposed at each branch point.

The first transport path 11 includes the image reading unit 140 in the transport path. The second transport path 12 includes the decoloring unit 160 in the transport path.

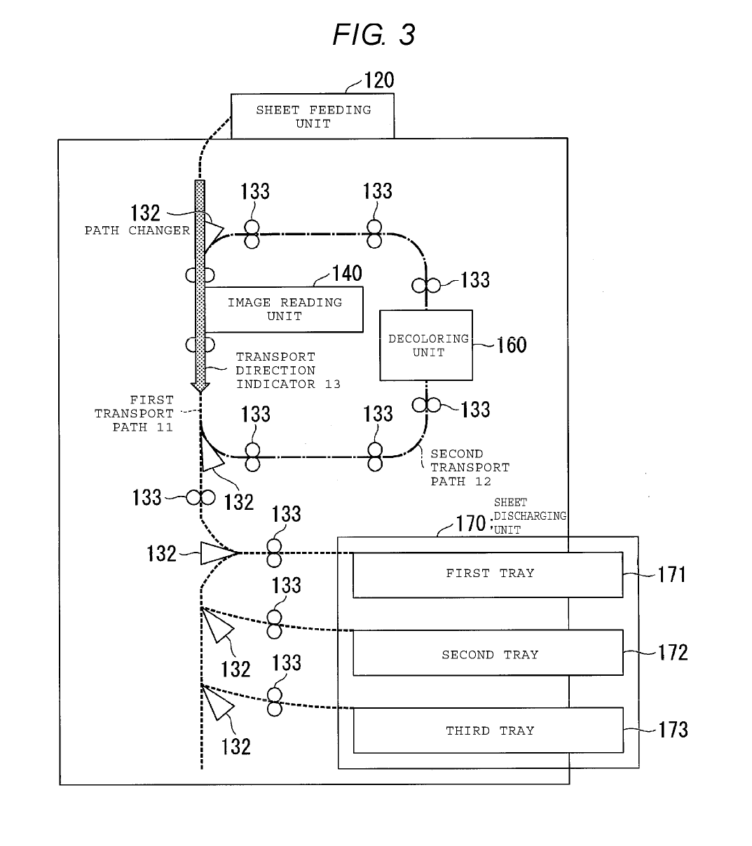

FIG. 3 shows a transport direction of the sheet in the first transport path 11 of the sorting device 1 before the decoloring process, with a transport direction indicator 13. The first transport path 11 transports the sheet before the decoloring process from the sheet feeding unit 120 to the second transport path 12 along the direction indicated by the transport direction indicator 13.

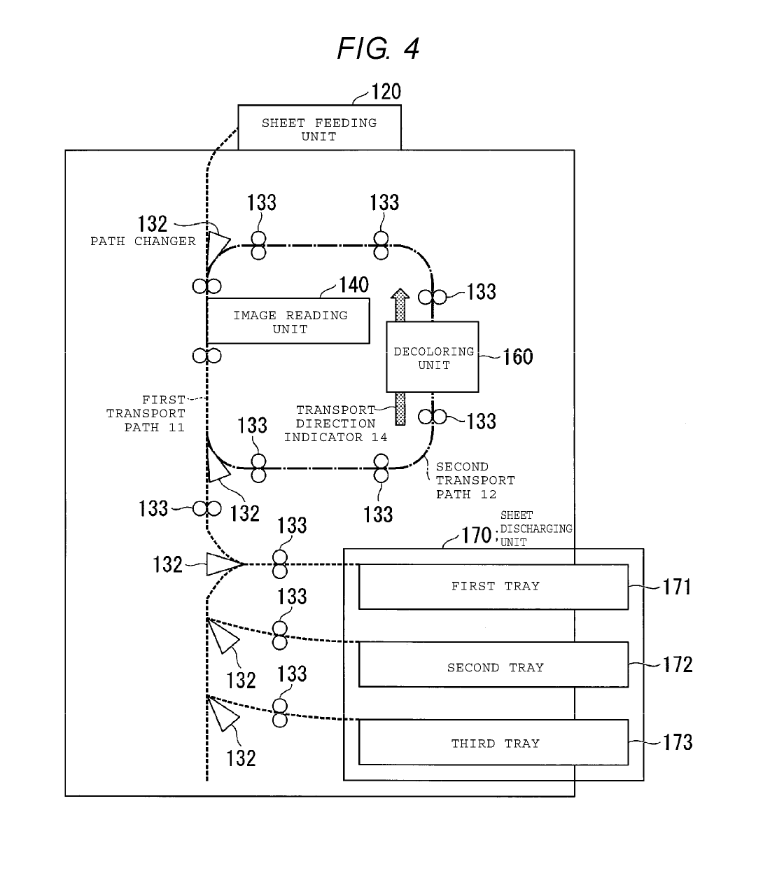

FIG. 4 shows a transport direction of the sheet on the second transport path 12 of the sorting device 1, with a transport direction indicator 14. The second transport path 12 transports the sheet before the decoloring process from the first transport path 11 to the decoloring unit 160 along the direction indicated by the transport direction indicator 14. The sheet is then transported from the decoloring unit 160 to the first transport path 11 along the direction indicated by the transport direction indicator 14.

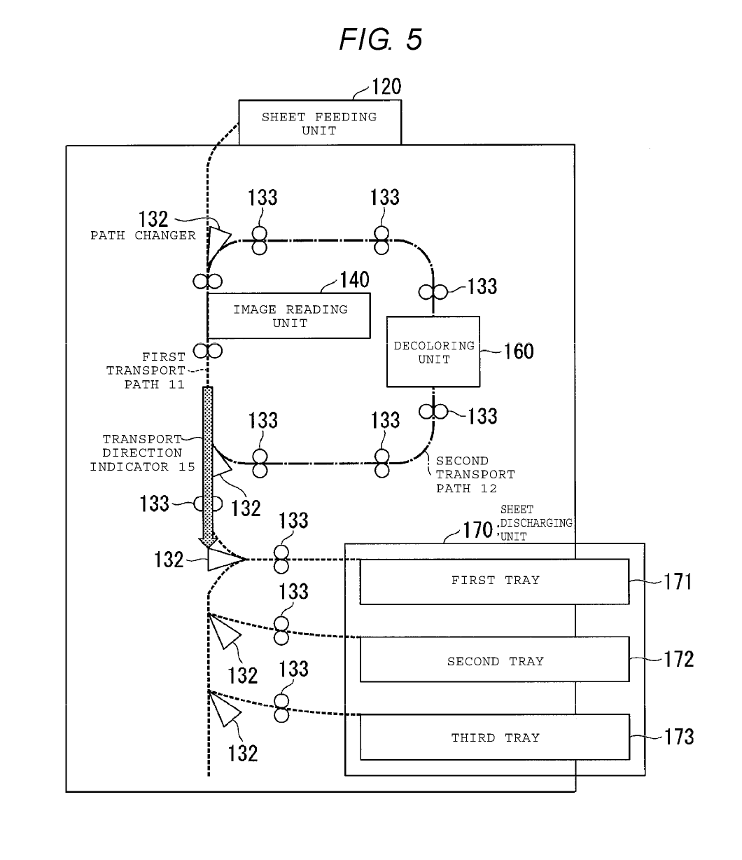

FIG. 5 shows a transport direction of the sheet in the first transport path 11 of the sorting device 1, after the decoloring process, with a transport direction indicator 15. The first transport path 11 transports the sheet after the decoloring process from the second transport path to the trays of the sheet discharging unit 170 along the direction indicated by the transport direction indicator 15. The image reading unit 140 in the transport path of the first transport path 11 generates the image of the surface of the sheet after the decoloring process.

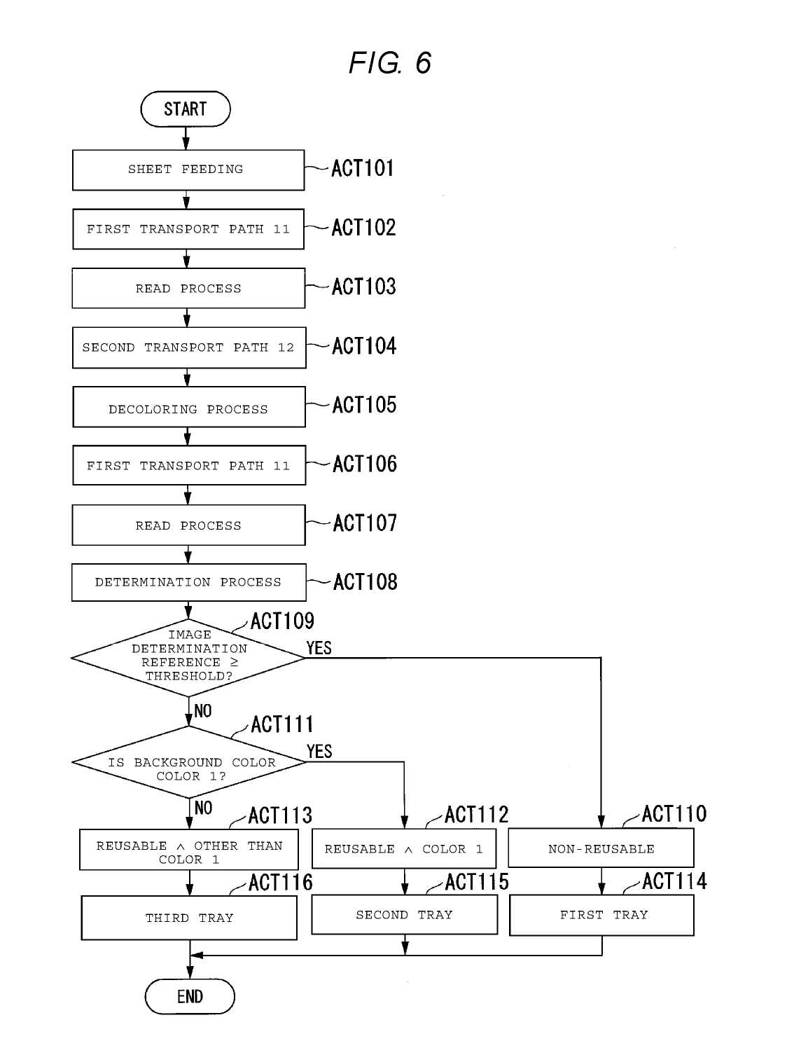

FIG. 6 is a flowchart showing an example sorting process of the sorting device 1. The sorting process of FIG. 6 assumes a case where there are three trays included in sheet discharging unit 170. For example, FIG. 6 shows the sorting process in a case of decoloring and sorting a sheet with a color 1 and a sheet with a color other than the color 1.

The sorting device 1 feeds the sheet via the sheet feeding unit 120 (ACT 101). The transporting unit 130 transports the fed sheet on the first transport path 11 (ACT 102). Next, the reading control unit 182 controls the image reading unit 140 to generate an image of the sheet, and the image storage unit 150 stores the generated image (ACT 103). Next, the transporting unit 130 transports the sheet sent from the first transport path 11 to the second transport path 12 (ACT 104). The decoloring unit 183 controls the decoloring unit 160 provided in the second transport path 12 to decolor the image on the sheet (ACT 105). After the decoloring process, the transporting unit 130 transports the sheet from the second transport path 12 to the first transport path 11 (ACT 106). Again, the reading control unit 182 controls the image reading unit 140 to generate an image of the sheet after the decoloring process, and the image storage unit 150 stores the generated image (ACT 107). Next, the determination unit 184 compares the image generated in ACT 103 and the image generated in ACT 107, and determines reusability of the sheet and the color of the sheet determined to be reusable (ACT 108). The reusability is determined based on whether or not an image determination reference is equal to or greater than a threshold instructed by a user (ACT 109). If the image determination reference is equal to or greater than the threshold (ACT 109: YES), the determination unit 184 determines that the sheet cannot be reused (ACT 110). If the image determination reference is less than the threshold (ACT 109: NO), the determination unit 184 determines the color of the sheet (ACT 111). If the color of the sheet is the color 1 (ACT 111: YES), the determination unit 184 determines that the sheet is a reusable sheet having the color 1 (ACT 112). If the color of the sheet is other than the color 1 (ACT 111: NO), the determination unit 184 determines that the sheet is a reusable sheet having a color other than the color 1 (ACT 113). Next, the transport control unit 181 delivers the sheet to a predetermined tray by controlling the transporting unit 130. For example, the transport control unit 181 delivers the sheet determined to be non-reusable to the first tray (ACT 114). For example, the transport control unit 181 delivers the reusable sheet whose the color is the color 1 to the second tray (ACT 115). For example, the transport control unit 181 delivers the reusable sheet whose color is other than the color 1 to the third tray (ACT 116). For example, it is assumed that there are four types of sheets, that is, sheets whose colors are red, blue, yellow, and black and that a color corresponding to the color 1 is red. In this case, the sheets whose colors are the remaining three types, that is, blue, yellow, and black are discharged to the third tray.

So far, a case where the number of trays of the sheet discharging unit 170 is three is described as a specific example. However, the number of trays of the sheet discharging unit 170 is not limited to three. Accordingly, it is possible to individually set the transport destination with respect to the sheets having more than three different colors.

### Modification Example

The sorting device 1 may be a device in which a decoloring function and a sorting function of the sheet as described above are performed in a single unified device, and may be a device in which the sorting function is performed in a device that is physically separate from the device in which the decoloring function is performed. In a case that the sorting device is separate from the decoloring device, the sheet is transferred to the device in which the sorting process is performed. The data generated as described above, such as the image generated before the decoloring process and a determination result of the determination unit 184, may be transmitted to a physically separate location through a network such as serial communication, parallel communication, or wireless communication. The data may be transmitted to another separate device in which the sorting process is performed, through a universal serial bus (USB). For example, the sorting function may be performed in an image forming device.

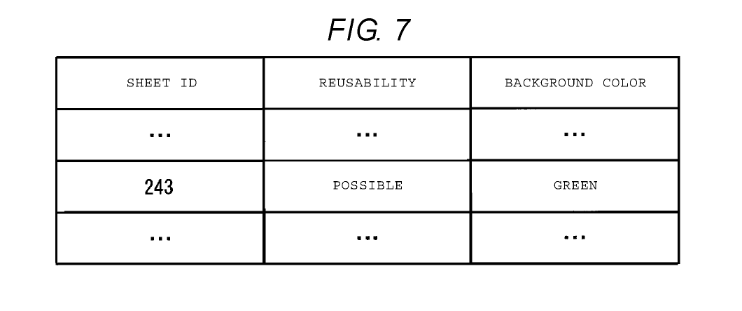

In a case where the sorting function is performed in a device different from the device that performs the decoloring function, a method may be used for collectively sorting a plurality of sheets after collectively decoloring images on the sheets. In this case, the data output by the device that performs the decoloring process may have a data format in which the reusability and the color of the sheet are stored for each of the sheets. FIG. 7 shows a specific example of the data format. A sheet ID of the i^{th} sheet, for example, indicates how many sheets there are from the first to the i^{th} sheet out of n total sheets. The reusability indicates whether or not the i^{th} sheet after the decoloring process can be reused. Background color indicates the color of the i^{th} sheet. Data in this data format is acquired, and sorting of the sheets is performed in another device in which only the sorting process is performed. For example, in FIG. 7, the 243^{rd} sheet is determined to be reusable and have a green color.

According to at least one embodiment described above, determining the color of the sheet makes it is possible to more easily sort the sheets having different colors after the decoloring process.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sheet sorting device comprising:
a transporting unit configured to transport a sheet;
a reading unit configured to generate an image of a surface of the sheet;
a decoloring unit configured to perform a decoloring processing to decolor an image on the sheet;
a plurality of sheet stacking trays; and
a processor configured to:
cause the reading unit to generate an image of the surface of the sheet after the decoloring unit performs the decoloring processing on the sheet,
determine a color of the sheet based on the generated image,
determine one sheet stacking tray out of the plurality of sheet stacking trays as a transport destination of the sheet, based on the determined color, and
control the transporting unit to transport the sheet to the determined sheet stacking tray.

2. The sorting device according to claim 1, wherein the processor is further configured to:
control the reading unit to generate a first image of the surface of the sheet before the decoloring unit performs the decoloring process on the sheet and to generate a second image of the surface of the sheet after the decoloring unit performs the decoloring process on the sheet, and
determine whether the sheet is reusable based on the first image compared to the second image.

3. The sorting device according to claim 2, wherein the processor determines the one sheet stacking tray out of the plurality of sheet stacking trays as the transport destination further based on whether the sheet is determined to be reusable.

4. The sorting device according to claim 2, wherein the processor does not perform the determination of the color of the sheet if the sheet is determined to not be reusable.

5. The sorting device according to claim 1, wherein
the processor determines a first sheet stacking tray out of the plurality of sheet stacking trays as the transport destination if the determined color of the sheet is a first color, and
the processor determines a second sheet stacking tray different from the first sheet stacking tray out of the plurality of sheet stacking trays as the transport destination if the determined color of the sheet is not the first color.

6. The sorting device according to claim 1, wherein the processor is further configured to:
control the transport unit to transport the sheet to the reading unit to generate a first image of the surface of the sheet before the decoloring unit performs the decoloring process on the sheet,
control the transport unit to convey the sheet to the decoloring unit to perform the decoloring processing on the sheet after first conveying the sheet through the reading unit,
control the transport unit to convey the sheet to the reading unit again to generate a second image of the surface of the sheet after conveying the sheet through the decoloring unit, and
determine whether the sheet is reusable based on the first image compared to the second image.

7. The sorting device according to claim 6, wherein the processor determines the one sheet stacking tray out of the plurality of sheet stacking trays as the transport destination further based on whether the sheet is determined to be reusable.

8. A non-transitory computer readable medium containing instructions causing a sheet processing device that includes a reading unit configured to generate an image of a surface of the sheet and a plurality of sheet stacking trays to perform a sheet sorting method comprising the steps of:
determining a color of the sheet based on the image generated by the reading unit,
determining one sheet stacking tray out of the plurality of sheet stacking trays as a transport destination of the sheet, based on the determined color, and
transporting the sheet to the determined sheet stacking tray.

9. The non-transitory computer readable medium according to claim 8, wherein the sheet processing device further includes a decoloring unit configured to perform a decoloring processing on the sheet, and the sheet sorting method further comprises the steps of:
generating, with the reading unit, a first image of the surface of the sheet before the decoloring unit performs the decoloring process on the sheet;
performing, with the decoloring unit, the decoloring processing on the sheet;
generating, with the reading unit, a second image of the surface of the sheet after the decoloring unit performs the decoloring process on the sheet; and
determining whether the sheet is reusable based on the first image compared to the second image.

10. The non-transitory computer readable medium according to claim 9, wherein the transport destination is determined further based on whether the sheet is determined to be reusable.

11. The non-transitory computer readable medium according to claim 9, wherein the instructions cause the sorting device to not perform the determination of the color of the sheet if the sheet is determined to not be reusable.

12. The non-transitory computer readable medium according to claim 8, wherein
a first sheet stacking tray out of the plurality of sheet stacking trays is determined as the transport destination if the determined color of the sheet is a first color, and
a second sheet stacking tray different from the first sheet stacking tray out of the plurality of sheet stacking trays is determined as the transport destination if the determined color of the sheet is not the first color.

13. The non-transitory computer readable medium according to claim 8, wherein the sheet processing device further includes a decoloring unit configured to perform a decoloring processing on the sheet, and the sheet sorting method further comprises the steps of:
conveying the sheet to the reading unit to generate a first image of the surface of the sheet before the decoloring unit performs the decoloring process on the sheet;
conveying the sheet to the decoloring unit to perform the decoloring processing on the sheet after first conveying the sheet through the reading unit;
conveying the sheet to the reading unit again to generate a second image of the surface of the sheet after conveying the sheet through the decoloring unit; and
determining whether the sheet is reusable based on the first image compared to the second image.

14. The non-transitory computer readable medium according to claim 13, wherein the one sheet stacking tray out of the plurality of sheet stacking trays is determined as the transport destination further based on whether the sheet is determined to be reusable.

15. A decoloring device comprising:
a transporting unit configured to transport a sheet;
a reading unit configured to generate an image of a surface of the sheet;
a decoloring unit configured to perform a decoloring processing to decolor an image on the sheet; and
a processor configured to:
control the reading unit to generate a first image of the surface of the sheet before the decoloring unit performs the decoloring process on the sheet,
control the decoloring unit to perform the decoloring processing on the sheet,
generate a second image of the surface of the sheet after the decoloring unit performs the decoloring process on the sheet,
determine a color of the sheet based on at least one of the first image and the second image,
determine whether the sheet is reusable based on the first image compared to the second image,
generate data that includes, in association, an identification of the sheet, the determined color of the sheet, and whether the sheet is determined to be reusable, and
output the generated data to a separate sorting device.

16. The decoloring device according to claim 15, wherein
the data is generated with respect to each of a plurality of sheets on which the decoloring processing is performed.

17. The decoloring device according to claim 16, wherein the processor controls the transporting unit to transport each of the plurality of sheets on which the decoloring processing is performed to the separate sorting device.
